(19) United States
(12) Patent Application Publication
(10) Pub. No.: US 2010/0145479 A1
(43) Pub. Date: Jun. 10, 2010

(54) Wireless Portable Sensor Monitoring System

(75) Inventor: Georgia Griffiths, Encinitas, CA (US)

Correspondence Address: PROCOPIO, CORY, HARGREAVES & SAVITCH LLP, 530 B STREET, SUITE 2100, SAN DIEGO, CA, 92101, US

(73) Assignee: G2 SOFTWARE SYSTEMS, INC., San Diego, CA (US)

(21) Appl. No.: 12/576,100

(22) Filed: Oct. 8, 2009

Related U.S. Application Data
(60) Provisional application No. 61/104,145, filed on Oct. 9, 2008.

(51) Int. Cl. G05B 19/042; G05B 13/02

(52) U.S. Cl. 700/17; 700/49

(57) ABSTRACT

Systems and methods for operating a wireless sensor monitoring system are provided. The sensor monitoring system includes one or more portable sensor devices deployed at a remote location. The system also includes a controller server configured to automatically detect the one or more portable sensor devices via a network connection, to receive sensor data from the sensor devices, process the sensor data using user-defined rules, and to send commands to the sensor devices instructing the devices to perform various actions. The controller server is further configured to provide a user interface for accessing sensor data from the portable sensor devices, generating a map interface of the remote location that displays the positions of the sensor devices, for receiving rule definitions to actions to be taken at specific times or if specified events occur, and for generating alerts and reports from sensor data.

### RELATED APPLICATION

This application claims the benefit of U.S. Provisional Patent Application Ser. No. 61/104,145, filed Oct. 9, 2008, entitled WIRELESS PORTABLE SECURITY MANAGEMENT SYSTEM, which is hereby incorporated by reference in its entirety.

### GOVERNMENT LICENSE RIGHTS

The U.S. Government has a paid-up license in this invention and the right in limited circumstances to require the patent owner to license others on reasonable terms as provided for by the terms of Navy Contract Nos. N00039-06-C-0109 and N00039-08-C-00602 awarded by the U.S. Navy.

### FIELD OF INVENTION

The present invention generally relates to sensor monitoring systems and more particularly relates to portable and customizable sensor systems.

### BACKGROUND

Sensor monitoring systems are often used to gather data and/or to monitor activities at a facility, such as a factory, and office, or a hospital. Security systems are one common type of sensor monitoring system. Conventional security systems in the market today range from very expensive and complex high end security systems to very basic and rigid low end systems. The high end systems are highly complex and typically must be installed and managed by expensive security companies. Although these conventional high end security systems are feature rich, they are extremely expensive to install and manage, and fail to offer portability.

At the other end of the spectrum, conventional low end security systems are highly limited in the type of monitoring performed and lack the ability to be reconfigured or customized for use in different environments and lack the ability for targeted messaging and notifications. Additionally, typical battery operated devices in these conventional low end systems have limited battery life, which significantly reduces their effectiveness.

### SUMMARY

Systems and methods for operating a portable and customizable sensor monitoring system are provided. The sensor monitoring system includes one or more portable sensor devices deployed at a remote location. The system also includes a controller server configured to automatically detect the one or more portable sensor devices via a network connection, to receive sensor data from the sensor devices, process the sensor data using user-defined rules, and to send commands to the sensor devices instructing the devices to perform various actions. The controller server is further configured to provide a user interface for accessing sensor data from the portable sensor devices, generating a map interface of the remote location that displays the positions of the sensor devices, for receiving rule definitions to actions to be taken at specific times or if specified events occur, and for generating alerts and reports from sensor data.

According to an embodiment, a sensor monitoring system is provided. The sensor monitoring system includes a computer readable storage device for storing computer executable programmed modules, a processor communicatively coupled with the computer readable storage device for executing programmed modules stored therein. The sensor monitoring system also includes a control module stored in the computer readable storage device. The control module is configured to manage and control the wireless sensor monitoring system. The sensor monitoring system also includes a sensor module stored in the computer readable storage device. The sensor module configured to automatically detect a plurality of sensor devices deployed at a remote location and manage data access to and from the plurality of sensor devices. The sensor monitoring system further includes a display and mapping module stored in the computer readable storage device. The display and mapping module configured to display a map interface including an image of the remote location being monitored by the plurality of sensors and a location of each of the plurality of sensors deployed at the remote location.

According to another embodiment, a computer implemented method for operating a sensor monitoring system is provided. According to this method, one or more processors are programmed to perform steps that include detecting a plurality of portable sensor devices deployed at a remote location, the plurality of portable sensor devices being detected using a controller server, and receiving, at the controller server, sensor data from the plurality of sensor devices that have been detected. The steps also include displaying a map interface displaying an image of the remote location being monitored by the plurality of sensors and a location of each of the plurality of sensors deployed at the remote location.

According to yet another embodiment, a computer-readable storage medium having stored thereon one or more sequences of instructions for causing one or more processors to perform the steps for operating a sensor monitoring system is provided. The steps include detecting a plurality of portable sensor devices deployed at a remote location, and receiving sensor data from the plurality of sensor devices that have been detected. The steps also include displaying a map interface displaying an image of the remote location being monitored by the plurality of sensors and a location of each of the plurality of sensors deployed at the remote location.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a network diagram illustrating an example of one possible configuration of a portable and customizable sensor monitoring system according to an embodiment of the present invention;

FIG. 2 is a block diagram illustrating an example controller according to an embodiment of the present invention;

FIG. 3 is a flow diagram illustrating an example process for execution of a timer event rule according to an embodiment of the present invention;

FIG. 4 is a flow diagram illustrating an example process for execution of a trigger event rule according to an embodiment of the present invention;

FIG. 5 is a block diagram illustrating an example wireless communication device that may be used in connection with various embodiments described herein;

FIG. 6 is a block diagram illustrating an example computer system that may be used in connection with various embodiments described herein;

FIG. 7 is a block diagram of a mapping interface according to an embodiment;

FIG. 8 is a flow diagram illustrating a process for registering sensor devices with the sensor system and monitoring the connectivity of the sensor devices according to an embodiment;

FIG. 9 is a flow diagram illustrating a process for creating a new rule according to an embodiment;

FIG. 10 is a flow diagram illustrating a process for processing requests for sensor data according to an embodiment;

FIG. 11 is a flow diagram illustrating a process for processing queries for archived sensor data;

FIG. 12 is a flow diagram illustrating a process for processing a delete data command according to an embodiment;

FIG. 13 illustrates an example of a trigger event rule that may be executed in response to an event and a sequence of steps leading to the execution of the rule according to an embodiment;

FIG. 14 illustrates an example of a timer event that may be executed at a predetermined time according to an embodiment; and

FIG. 15 illustrates an example of another mapping interface according to an embodiment

### DETAILED DESCRIPTION

Systems and methods are disclosed herein that provide for a portable and customizable sensor monitoring system including a controller server and a reconfigurable group of portable sensor devices. A controller server is configured to manage a customizable group of portable sensor devices. The portable sensor devices may include various types of devices configured to collect and/or store sensor data, such as motion detectors, contact sensors, trip wires, vibration sensors, temperature and/or other environmental sensors, imaging sensors, including video and still cameras, and the like. The portable sensor devices can be communicatively linked to the controller server via a wired or wireless communication network or a direct wired or wireless transmission link.

The controller server manages each of the portable sensor devices, and the controller server is further configured to allow an operator add, remote, relocate, and configure portable sensor devices as desired. The controller server is also programmable to carry out various sensor monitoring and control functions including real time notifications to an operator or manager or other person or device (e.g., via an electronic messaging means), execution of timed scripts, sensor tours, sensor triggered scripts based on user customizable rule sets. The controller server allows a user to reconfigure the sensor monitoring system in real time to ignore sensors, change the dynamics between sensors and their activation of other controlled sensors or communications to users. The system is fully portable, and many of the portable sensors are battery operated, enabling the system to be set up in just minutes in almost any location.

Embodiments of the sensor monitoring system described herein may be used for various implementations, such as a security system or a system for monitoring activity in a hospital room or other type of care facility. Many of the embodiments described herein are directed to use of the sensor monitoring system as a security system or in a health care facility. However these embodiments are merely one set of embodiments provided to illustrate the flexibility of the sensor monitoring system. One skilled in the art will recognize that the portable sensor monitoring system described herein may be used in other embodiments where gathering and processing of sensor data from portable sensors in remote locations is desirable. For example, embodiments of the sensor monitoring system may be used in a traditional office setting, a factory or fabrication facility, or other environment to monitor staff, equipment, environmental conditions, as well as events that take place in the environment.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

FIG. 1 is a network diagram illustrating an example of one possible configuration of a sensor monitoring system 10 according to an embodiment. In the illustrated embodiment, the system 10 includes a controller 20 that is communicatively coupled with a plurality of portable sensors 30, 40, and 50 and one or more user devices 60 and 70 via networks 100 and 110.

Also shown is a gateway 90 that provides wireless access for sensors 40 and 50 to the network 100. Gateway 90 may also translate communications from a sensor device for delivery over the network 100. For example, communications from a sensor that are in a proprietary or alternative format that are received by the gateway device can be translated or reformatted by the gateway device into standard TCP/IP communications for delivery over the network 100. Gateway 90 may also translate communications received from the controller 20 via network 100 into the proprietary or alternative format used by the sensor device. In one embodiment, the gateway 90 provides an application programming interface (“API”) to allow programmed control of sensors from the controller 20. Throughout the methods disclosed herein, the controller 20 is described as interfacing with one or more of the sensor devices directly over the network where commands and/or data are exchanged between the controller 20 and the sensor devices over the network. One skilled in the art will recognize that each of these exchanges of commands and/or data may pass through a gateway 90.

Each of the devices in the system 10 is configured with some sort of volatile or persistent data storage capability, for example a memory or hard drive in controller 20. In one embodiment, data storage 25 for the controller 20 may be implemented as a relational database that is used to store captured sensor data. The data can be indexed, e.g., by a sensor identification number, sensor type, timestamp (e.g., date and time), and nature of the capture by the sensor (e.g., Guard Tour, Business Rule, user query, alert-generated). This data can serve as the basis for quick report generation. These reports can, in some embodiments, be accessed via a web page interface provided by controller 20. The data is indexed such that user descriptions and details can be changed to enhance portability without losing the relation to triggers, security checks, etc. In an embodiment, a global positioning system (“GPS”) data can be associated with the sensor data and be displayed on the user interface provided by the sensor monitoring system.

In an embodiment, the controller 20 includes a set of compiled or scripted software modules that can be executed on various programmable computer platforms. Controller 20 communicates with the user devices, the portable sensor devices, the gateway, and other devices over the networks 100 and 110. In one embodiment, controller 20 is implemented as a set of software applications or modules stored in a computer-readable memory of a computer system. These software applications or modules, when executed by the processor of the computer system perform the various functions of the controller 20 described herein. In one embodiment, the controller 20 is implemented in platform independent Java code that can be executed by a Java Virtual Machine, enabling the controller 20 to be run on any computer system on which the Java Virtual Machine is supported.

The sensors 30, 40, and 50 include any sort of sensor device capable of communicating over the networks 100 and 110. For example, the sensor devices may include still cameras, video cameras, motion detectors, trip beam sensors, heat sensors, pressure sensor, moisture sensors, contact sensors, and/or other types of sensing device. Other types of sensors with situational awareness may also be used with the sensor monitoring system. For example, sensors for monitoring the temperature of a room, the movement of employees through a facility, the number of people entering and exiting the facility, water flow or electrical usage. Sensors could also be used to monitor the vital signs of a patient and/or which medications that the patient has been given.

The sensors 30, 40, and 50 may include a persistent or volatile memory 35, 45, and 55 for storing data gathered by the sensors. In an embodiment, the sensors 30, 40, and 50 may be configured to automatically send the data gathered by the sensors to the controller periodically. In another embodiment, the sensors 30, 40, and 50 may store the information in the persistent memory 35, 45, and 55 until the data is requested by controller 20. In an embodiment, the sensors 30, 40, and 50 are portable sensor devices that can be relocated within a facility being monitored by the sensor monitoring system or can be moved to a different facility to be monitored and reconfigured to operate from the new facility. In an embodiment, the sensor devices 30, 40, and 50 operate on battery power, allowing a user to move or place the sensor devices 30, 40, and 50 in locations where an external power source, such as an electrical outlet connected to a building's electrical system if not readily available.

The user devices 60 and 70 can also be any sort of computing device capable of communicating over the networks 100 and 110, for example a personal computer, personal digital assistant (“PDA”), telephone, workstation, or the like. The controller 20 encapsulates the interface to the network via the sensor module 210 to ensure that new sensors and external features can be easily added to the system without needing to rewrite the application.

Network 100 or 110 can be a wired network, wireless network, or a combination of homogeneous or heterogeneous networks including both wired and wireless network segments. Network 100 or 110 can be a personal area network (“PAN”), local area network (“LAN”), or a wide area network (“WAN”), a private network, public network, or a combination of networks collectively comprising a global communications network such as the Internet. Network 100 or 110 can be an ad hoc network or a persistent network and can be fixed in location, mobile, or may comprise a combination of fixed and mobile components. Additionally, network 100 or 110 may carry communications corresponding to a single network protocol or to multiple network protocols such as 802.11, 802.15, 802.16, and TCP/IP, just to name a few.

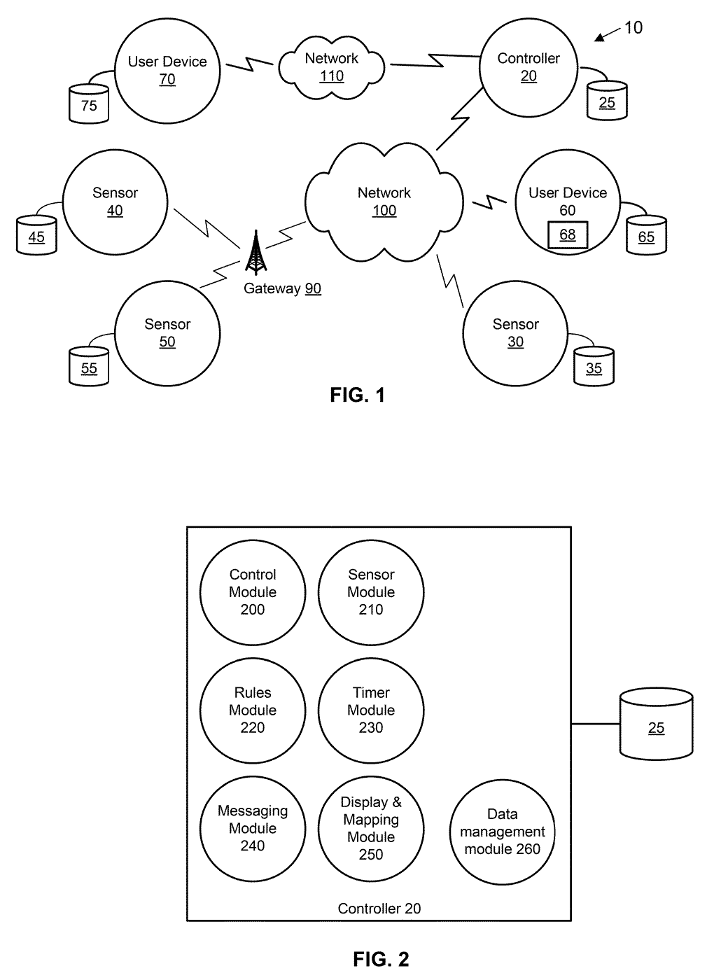

FIG. 2 is a block diagram illustrating an example controller 20 according to an embodiment of the present invention. In the illustrated embodiment, the controller 20 comprises a control module 200, sensor module 210, a rules module 220, a timer module 230, a messaging module 240, a display and mapping module 250, and a data management module 260. The modularity of the design allows for extensibility and user separation.

The control module 200 is configured to manage and control a wireless sensor monitoring system. The controller 20 implements one or more application programming interfaces (“API”) that allow other devices and modules to communicate with the various modules on the controller 20 and vice versa. For example, an API can be used to facilitate communications between the controller 20 and the gateway 90 and various sensors. Controller 20 may include one or more sensor-specific proprietary APIs that enable the use of sensors from different manufacturers to be included in the wireless sensor monitoring system 10.

The controller 20, in addition to the one or more APIs supports connections to one or more data storage areas, e.g., implemented as a database, connections to one or more desktop applications, and connections to one or more networks, e.g., including the ubiquitous Internet, as previously illustrated in FIG. 1.

The control module 200 operates to manage the overall function of the controller 20 and its various communications with sensors, other devices, and operators and/or users. In one embodiment, the control module 200 implements a user interface and/or communicates with a desktop application that provides a user or operator with setup and control capabilities, database access, and sensor mapping capabilities. The desktop application may be an application resident on a user device or it may execute on the controller 20 and be visible on the user device, e.g., via a web interface. In one embodiment, the web interface can be utilized for all functions, and serves as an alternative to the client. In embodiments where the web application is used, no desktop application or other custom software need be installed on the user device. Instead, an operator can access the control interface from a standard browser application installed on the user device.

Advantageously, the control module 200 operates in concert and communication with the various other modules on the controller 20 to carry out the necessary functions of the controller 20 to implement the sensor monitoring system.

The control module 200 is also configured to enable a user or operator to create user accounts, setup messaging characteristics, configure and monitor the portable sensor device monitoring network and its various sensors, assign descriptions to individual sensors in the portable sensor device network, setup alert criteria, business rules, timers, create, modify and delete predetermined sets of instructions, and setup sensor activations and image capture characteristics. The control module 200 is also configured to create sensor maps in combination with the display and mapping module 250 and place active sensor icons on maps based on physical location.

The sensor module 210 is configured to manage and control one or more groups of sensors in the wireless portable sensor monitoring system. The sensor module 210 can configure and reconfigure the various sensors in the system either directly (e.g., for those sensors capable of native IP communication) or indirectly (e.g., via gateway 90 acting as translator). The sensor module 210 includes sensor discovery functionality that allows the sensor module 210 to discover sensors dynamically coming in to and out of the network, and can also configure sensor networks to disallow any dynamic entry or exit of sensor devices from the network. The sensor module 210 is configured to monitor the connectivity of sensors on the network and to broadcast a sensory discovery message on the local network where a sensor or sensors have been installed but not yet connected with controller 20.

The sensor module 210 also maintains a list of sensor devices that have been registered with controller 20, and the sensor module 210 periodically sends a command to each sensor device at the network address registered for that sensor device to determine whether the sensor device is still accessible at that network address. The network addresses of the sensor devices may be dynamically assigned using DHCP or another similar protocol, so network addresses assigned to the sensor devices may change over time. If a sensor device does not respond to the command sent by the sensor module 210, the sensor module 210 may broadcast a find sensor message over the local network where the sensor device was last known to have been installed. Each sensor device receiving the broadcast message responds with an identifier for the device and the network address of the device. The sensor module 210 then updates the list of registered devices using this information. Any sensor devices that do not respond are marked as inoperable.

The rules module 220 is configured to receive sets of rules (e.g., business rules) from an operator or user and store those rule sets for later operation. The rules define a condition to be satisfied and a set of actions to be performed if the condition is satisfied. Trigger event rules are rules that are to be executed upon on the occurrence of a predefined trigger event or set of trigger events. For example, if motion is detected by a sensor (i.e., trigger event) then the rules module 220 in combination with the control module 200 can be employed to carry out certain predefined actions such as taking video footage of the area where the motion was detected, turning on or off lights in the area (if light control is part of the sensor monitoring system), and sending a message to an operator or user (e.g., an email message, a text message, a telephonic message, and/or other form of electronic message).

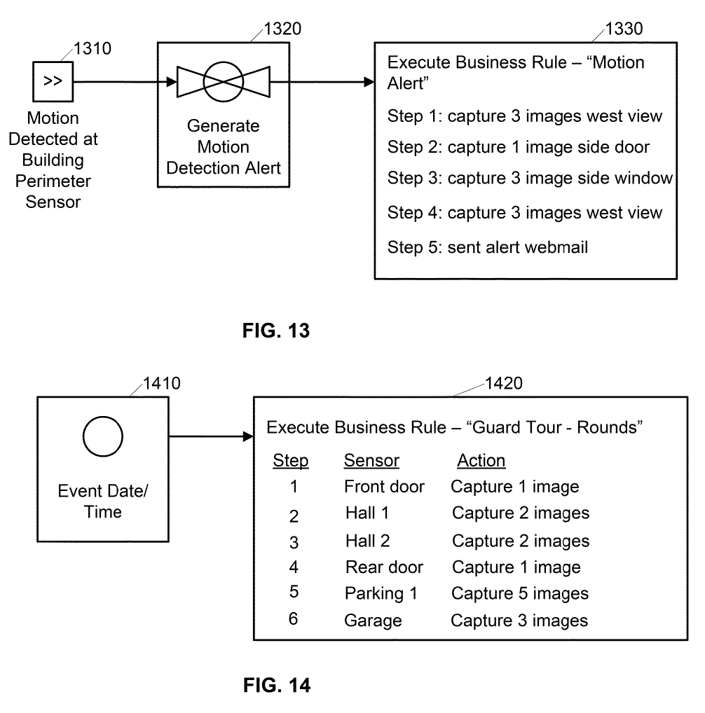

FIG. 13 illustrates an example of a trigger event rule that may be executed in response to an event and a sequence of steps leading to the execution of the rule according to one embodiment. The trigger event rule illustrated in FIG. 13 can be used in an implementation of a security system using the sensor monitoring systems and methods described herein. The trigger event rule defines a set of actions to be executed upon the occurrence of the event. A motion sensor deployed at a client site is triggered (block 1310) and the motion sensor generates a “motion detection alert” (block 1320) which is sent to the controller 20. In response to receiving the motion sensor alert, controller 20 executes the “motion alert” business rule. The business rule specifies a set of actions to be taken when a motion event is triggered. For example, in the present embodiment, controller 20 instructs various cameras deployed at the client site to take one or more images and to send those images to controller 20. The controller 20 also sends a webmail alert to an operator's user device 60 or 70 indicating that a motion sensor has been triggered at the client site. The controller 20 can also initiate other actions to alert the client, such as sending a text message or initiating a telephone call to the client. In an embodiment, the controller 20 may also alert authorities of a possible intrusion.

Different types of rules can be defined for different sensors within the sensor network. For example, a first trigger event rule can be defined for motion sensors outside of a building and a second trigger event rule can be defined for motions sensors inside the building. According to the first business rule, if a motion sensor outside of a building is triggered, the controller 20 instructs cameras to take a series of photos around the perimeter of the building. According to the second business rule, if a motion sensor inside of the building is triggered, photos of the inside of the building may be taken, and the client and/or authorities alerted of a possible intrusion.

Another type of rule that a user or operation may define is timer event rules. Timer event rules are rules that define a set of actions to be performed at a specific time or date and time. Timer events are placed onto a master schedule that is monitored by the timer module 230 of the controller 20.

Returning now to FIG. 2, the timer module 230 is configured similar to the rules module, however instead of carrying out certain predefined actions upon the occurrence of a trigger event, the timer module 230 works in combination with the control module 200 to carry out certain predefined actions at a particular predetermined time.

FIG. 14 illustrates an example of a timer event rule that defines a set of steps that are to be executed by controller 20 at a particular time or date and time according to an embodiment. The time event rule illustrated in FIG. 14 can be used in an implementation of a security system using the sensor monitoring systems and methods described herein. These steps may include various actions, such as checking the sensor status of sensors or retrieving sensor data from the sensors. In the present embodiment, the timer event includes a date and time (block 1410) and a set of steps to be performed at the specified date and time. According to an embodiment, timer events can also be defined as recurring events that are to be executed periodically by controller 20. For example, a timer event can be defined that occurs every day at 12:00 or occurs once every hour.

The exemplary rule illustrated in FIG. 14 simulates a guard performing rounds of a building, but rather than a person physically visiting each of the locations, one or more images are captured at each location and forwarded to the controller 20.

Returning again to FIG. 2, the messaging module 240 is configured to send and receive messages for the sensor monitoring system. For example, notifications are sent by the messaging module to an operator or user, e.g., by electronic message—email, text message, or the like. The messaging module may also be employed to assist with communications to and from sensors, translation of such messages and or encoding and decoding of encrypted messages.

The display and mapping module 250 is configured to allow presentation of a map image (e.g., a map, photograph, or other visual representation of a location) on a user device along with an overlay of icons and images that, e.g., represent various sensors deployed in the wireless portable sensor monitoring system. In one embodiment, the display and mapping module 250 is also configured to work in concert with the control module 200 to provide sensor setup and monitoring information when the icon or other overlay for a particular sensor is selected by the user or operator.

Data management module 260 is configured to provide an interface to controller 20 to retrieving data from and storing data to data stores, such as data storage 25. The data management module 260 can receive requests to access data from or store data to an external data store from the other components of controller 20 and format the requests in a format that can be understood by the external data stores. For example, if data storage 25 is a relational database, data management module can convert a request received from a module of controller 20 to a query, such as a Structured Query Language (“SQL”) query. The data management module 260 can also receive data from the data store and convert the data to a format expected by the module requesting the data.

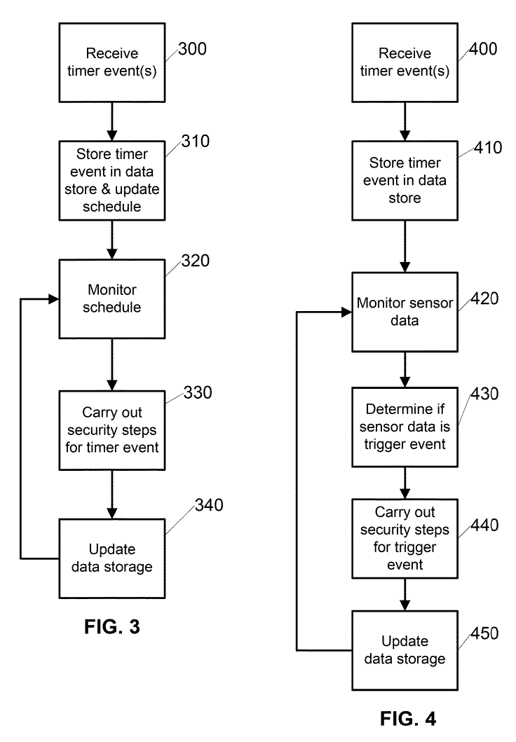

FIG. 3 is a flow diagram illustrating an example process for execution of a timer event rule according to an embodiment of the present invention. This process may be carried out by the controller 20 previously described with respect to FIG. 1. Initially, the rules module 220 of controller 20 receives the definition for one or more timer event rules that define events to be performed at a particular time or a particular date and time (step 300). In an embodiment, controller 20 stores the rules in data storage 25 and adds the rules to an event schedule maintained by controller 20 (step 310). The timer module 230 monitors the schedule to determine whether any timer event rules are to be triggered (step 320). In an embodiment, the timer module 230 periodically checks the schedule at a predetermined interval, such as every minute, every hour, every two hours. An operator may configure the predetermined interval to customize how often the timer module 230 checks the schedule.

If a timer event rule is found to be due to be triggered by the timer module 230, the timer module 230 initiates the execution of the timer event rule by the controller 20 to perform one or more actions associated with the rule (step 330). As described above, various actions can be associated with the timer event rule. More than one action and type of action can be associated with a timer event rule. For example, a timer event rule can request sensor status from one or more sensors, and request that cameras capture one or more images and provide the captured image data to controller 20. Controller 20 can store the received data in data storage 25 of controller 20 (step 340). The stored data can be archived and used to generate reports based on the captured sensor data.

FIG. 4 is a flow diagram illustrating an example process for execution of a trigger event rule according to an embodiment of the present invention. This process may also be carried out by the controller 20 previously described with respect to FIG. 1.

Initially, the rules module 230 of controller 20 receives the definition for one or more trigger event rules that define steps to take if a particular event occurs (step 400). The rules module 230 provides an interface that enables a user to define, modify and delete rules. In an embodiment, controller 20 stores the trigger event rule in data storage 25 (step 410). In an embodiment, the stored trigger event rules are referenced by event type to enable the rules module 230 to identify which rules may be triggered based on a specific event. For example, one trigger event rule having a first set of associated actions to be performed is triggered if a motion sensor outside of a building senses motion and generates a motion event while a second trigger event rule having a second set of associated actions to be performed is triggered if a motion sensor inside of a building senses motion and generates a motion event.

The sensor module 210 monitors the sensor data received from the sensors by controller 20 (step 420) to determine whether any trigger event rules are triggered by the sensor data (step 430). If a trigger event rule is triggered by the sensor data, the sensor module 230 initiates the execution of the trigger event rule by the controller 20 to perform one or more actions associated with the rule (step 440). As described above, various actions can be associated with the trigger event rule. More than one action and type of action may be associated with a trigger event rule. For example, a trigger event rule can request sensor status from one or more sensors, request that cameras capture one or more images and provide the captured image data to controller 20, and send an alert message to a user or operator. Controller 20 can store the received data in data storage 25 of controller 20 (step 450). The stored data can be archived and used to generate reports based on the captured sensor data. In an embodiment, a digital image is captured by a configured sensor, and that image is emailed to an assigned addressee.

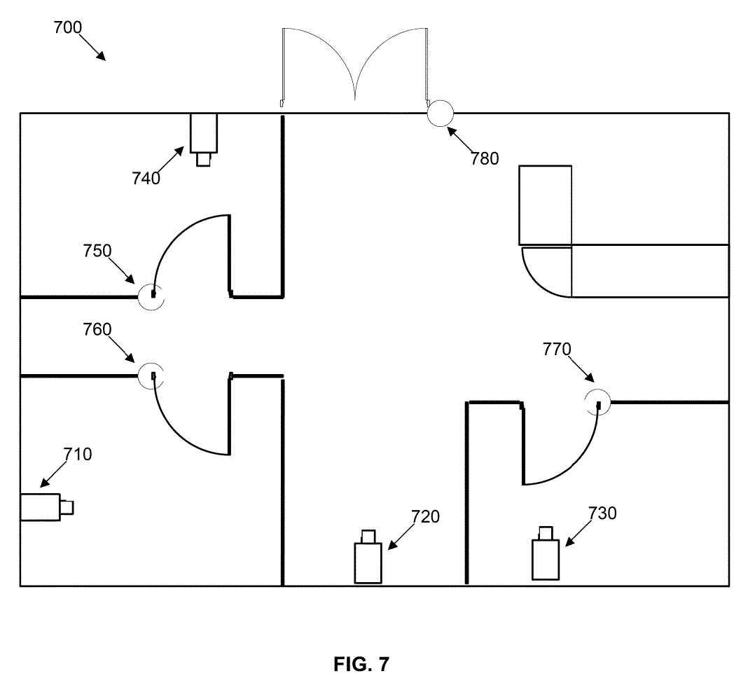

FIG. 7 is a block diagram of a map interface according to an embodiment. As described above, display and mapping module 250 is configured to generate an interactive map image of an area being monitored by a portable security system implemented using the sensor monitoring systems and methods described herein. The interactive map includes an overlay of icons or images that represent the location of the various sensor devices deployed at the area represented by the map. The area represented by the map may be determined based upon a blueprint of a building, a geographical map, or a drawing or other input provided by a user or operator that shows the physical attributes of the area represented by the map. In an embodiment, display and mapping module 250 generates the interactive map using a web page or series of web pages that the user may access via the user interface of the security system or alternatively by entering a Universal Resource Locator (“URL”) into a web browser running on a user device.

FIG. 7 illustrates an example of a mapping module interface that includes a map 700 of a facility being monitored according to an embodiment. The present embodiment illustrates a security system implemented using the sensor monitoring systems and methods disclosed herein. Camera icons 710, 720, 730, and 740 represent security cameras placed throughout the facility. Door monitor icons 750, 760, 770, and 780 represent door monitor sensors that monitor the opening and closing various doors into and within the facility. In an embodiment, the display and mapping module 250 provides a user interface that allows a user upload a floor plan or image of a location to be monitored by the security system. The display and mapping module 250 also provides a user interface that allows a user to place icons on the map representing various security sensors deployed in the area being monitored. In one embodiment, the user interface provides a “drag and drop” interface where a user is presented with a set of icons representing various sensor devices. The user can then drag the icons onto locations on the map corresponding to the locations where the sensor devices are deployed at the facility being monitored by the security system. The mapping module interface also allows users to logically remove sensors from the sensor network (whether the actual sensor has been physically removed or not). For example, a user may wish to logically remove a malfunctioning sensor from the security system or may wish to stop monitoring a particular area, or the like.

In an embodiment, the mapping module interface also allows a user to click an icon representing a particular sensor device to access information about the sensor device and/or to configure to sensor device. The sensor interface allows a user to view the status of a sensor (e.g., online or unavailable) and to request sensor data from the sensor device. The sensor interface may also display the information requested from the sensor device, e.g. images or video captured by a camera or an access log captured by a card reader device. The sensor interface may also include a configuration interface that provides an interface for adjusting the operating parameters of a sensor device. For example, a user may configure a door sensor to only capture sensor data in the evening when a facility being monitored typically is not staffed.

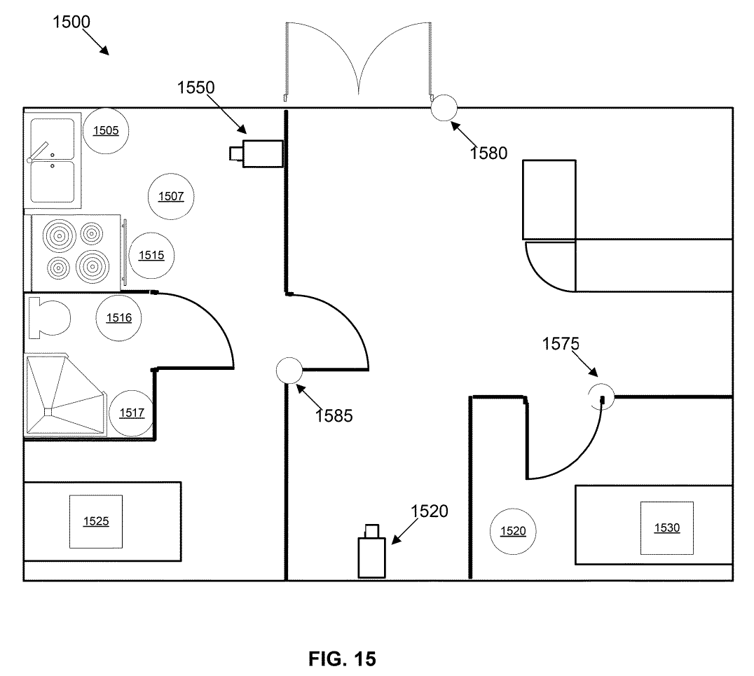

FIG. 15 illustrates another example of a mapping module interface that includes a map 1500 of a facility being monitored according to an embodiment. FIG. 15 illustrates a monitoring system implemented using the sensor monitoring systems and methods disclosed herein for use in a care facility such as a hospital or an assisted living facility. Portable sensor devices can be placed throughout the facility that monitor various aspects of patient activities and/or patient vital signs, visitor access to the facility, and staff actions, such as dispensing medication to patients, and access to the facility, and/or other relevant information. The facility illustrated in FIG. 15 includes an apartment-style room that includes a kitchen, bath, and bedroom and a hospital-style room that includes a bed, and a nursing station for staff to monitor activities occurring within the facility. The nursing station can include a computer system (not shown) that can be used to view the mapping module interface displaying the sensor data for the facility. In one embodiment, the facility could be a private dwelling.

The kitchen area of the apartment-style room includes a number of sensor devices for monitoring activities in the kitchen. The sink includes a water-flow sensor 1505 that monitors the water flow through the faucet. Data from the water-flow sensor 1505 can be used to determine whether a resident or care giver has left the faucet on the sink running. Other types of sensors might also be used, such as a water-level sensor to detect whether the sink is about to overflow or a temperature sensor to determine whether the water temperature of the water being dispensed by the faucet has exceeded a safe level. The kitchen also includes a smoke detector 1507, and a sensor 1515 on the stove. Sensor 1515 monitors the length of time that the stove has been turned on, which can trigger an alert if the stove remains on longer than a predetermined period of time, which may indicate that a resident or care giver has forgotten to turn off the stove. The kitchen also includes a video camera 1550 that may be used to monitor what is going on in the kitchen area by facility staff.

The bathroom includes a water flow sensor 1517 on the shower to monitor how long the water has been running and motion sensor 1516 monitors motion within the bathroom. Trigger event rules could be written to alert facility staff if the water in the shower has run for longer than a predetermined time period and there is no motion in the bathroom, which could indicate that a patient has fallen in the shower or may otherwise need assistance.

The beds include pressure sensors 1525 and 1530 that can be used to determine whether a patient is in the bed or has left the bed. The smaller hospital-style room includes a temperature sensor 1520 that monitors the temperature of the room.

Door sensors 1575, 1580, and 1585 monitor whether the various doors to the facility have been opened. The door sensors may also include an access control device such as a card reader or a pin pad that requires authorized access to open the door and to track who has entered.

The types of sensor devices illustrated in FIG. 15 are merely one example of the types of sensor devices that may be used. Other types of sensor devices, such as sensors for tracking whether a patient has been given medication may also be used. For example, a medication may include tag, such as a radio frequency identification (“RFID”) tag that could be detected by a sensor device in a patient's room to track which medications have been given to the patient.

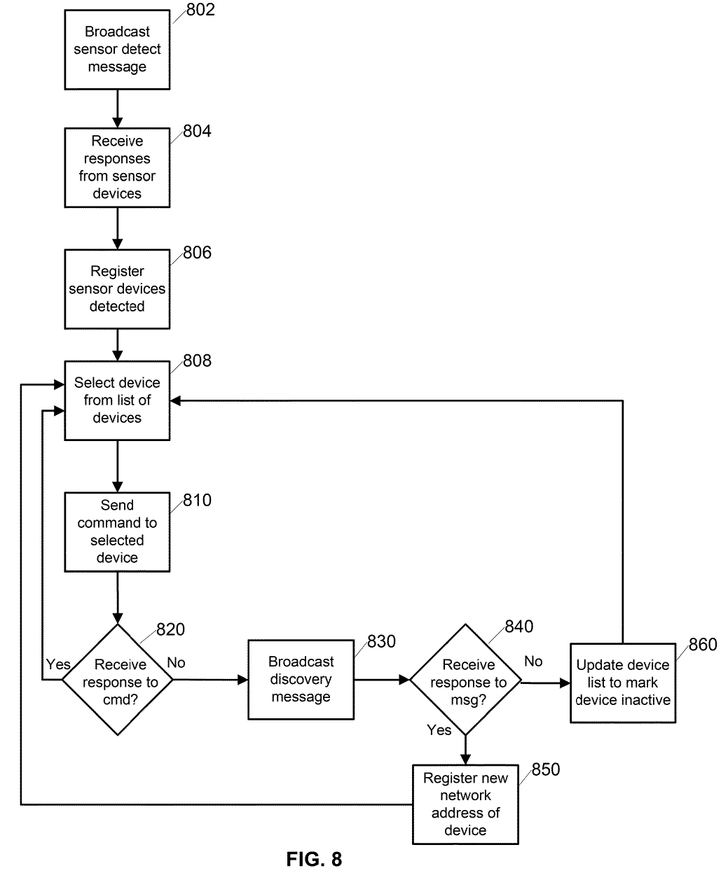

FIG. 8 is a flow diagram illustrating a process for registering sensor devices with the sensor monitoring system and monitoring the connectivity of the sensor devices according to an embodiment. The sensor module 210 of controller 20 monitors the sensor devices to ensure each known sensor device registered with the controller 20 remains at the network address under which the device is registered with controller 20. In an embodiment, the sensor devices may be allocated an Internet Protocol (“IP”) address on a local network on which the devices are installed using Dynamic Host Configuration Protocols (“DHCP”). The network addresses of the sensor devices may change over time. For example, if the network or a sensor device loses power, the sensor device may be assigned a new network address by the network when it regains power and rejoins the network.

Initially, when the sensor monitoring system is brought online, the sensor module 210 sends a broadcast message out to sensor devices installed on a local network of a remote location to be monitored (step 802). If one embodiment, the gateway 90 may send the broadcast message out on the local network on behalf of the sensor module 210. Each sensor device located on the local network of the remote location receiving the broadcast message from the sensor module 210 sends a response message to the controller 20 (e.g., directly or via gateway 90) that includes an identifier assigned to the sensor device and a network address of the device. The controller 20 receives the responses from the sensor devices (step 804), and registers the devices with the controller module 20 by adding the sensor device information to a list of sensor devices maintained by the controller 20 (step 806). According to some embodiments, a user or operator may also manually register a sensor device with the sensor monitoring system via a sensor configuration interface provided by the sensor module 210. The sensor information input by the user is added to the list of sensor devices registered with the system, and the system can also attempt to connect to the sensor device identified by the user to ensure that the sensor device is reachable by the controller 20. In an embodiment, the sensor configuration interface is a web page provided by the controller 20.

Periodically, the sensor module 210 verifies that each registered sensor device remains at the registered network address. The network address of a sensor device may change if the device is powered off and on or if the network to which the device is connected is reinitialized. The sensor module 210 selects a sensor device from the list of registered sensor devices (step 808) and sends a command to the selected sensor device (step 810). The sensor module 210 then waits for a response from the sensor device (step 820). If the sensor device responds to the command from the sensor module 210, then the sensor module 210 selects a next sensor device from the list of registered sensor devices (step 808).

Otherwise, if the sensor device does not respond to the command from the sensor module 210, the sensor module enters a find device mode where the sensor module broadcasts a discovery message on the local network on which the device is supposed to be located (step 830). The broadcast message requests that the sensor devices located on the local network send a response to the controller 20 that identifies the network address of the sensor device. If the sensor module 210 receives a response to the broadcast message from the sensor device, the sensor module 210 updates the information in the list of registered sensor devices to include the current address of the sensor device (step 850). If the sensor module 210 does not receive a response to the broadcast message, the sensor module 210 updates the information in the list of registered sensor devices to indicate that the sensor is currently inoperable (step 860).

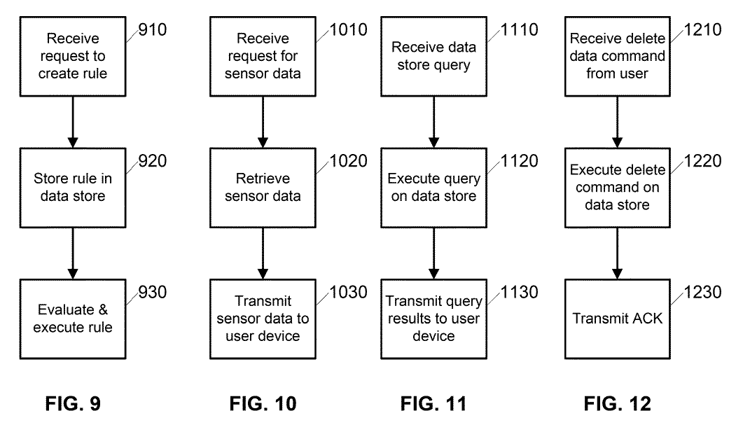

FIG. 9 is a flow diagram illustrating a process for creating a new rule according to an embodiment. A user or operator may create new rules (e.g., trigger event rules, timer event rules) or modify existing rules. Controller 20 provides a user interface, such as web page, that enables a user or operator to define new rules or modify existing rules. The controller 20 receives a request to create a new rule from a user via the user interface (step 910). The controller 20 then receives the information that defines the new rule (e.g., time/trigger and steps to be carried out) and stores the new rule in the data store (step 920). For timer event rules, the controller 20 updates the master schedule to include the timer event rule. The controller 20 then evaluates the rule's triggering criteria (e.g., sensor data or date/time) and if they have been met, executes the rule (step 930). For trigger event rules, the controller 20 determines whether sensor data from the sensor devices meets the triggering criteria of the rule and performs the actions defined in the rule. For timer event rules, the controller 20 checks the current time or date and time to determine whether the data or date and time criteria for the rule have been satisfied, and performs the actions defined in the rule if the criteria have been satisfied.

FIG. 10 is a flow diagram illustrating a process for processing requests for sensor data according to an embodiment. A user or operator may submit a request to the controller 20 for sensor data from one or more sensor devices via the user interface of controller 20. Controller 20 receives the request for the sensor data (step 1010) and sensor module 210 of controller 20 retrieves the data from the sensors specified in the request (step 1020). Controller 20 then transmits the requested sensor data to the user or operator (step 1030). In an embodiment, controller 20 may generate an email, a text message, a video message, an image that includes the requested sensor data. In an embodiment, controller 20 generates a web page that displays report that provides the sensor status of the requested sensors specified in the request as well as displaying any sensor data, such as images and video that has been received from the sensor devices. The sensor data may also be stored in the data storage area 25 of controller 20 for later viewing by the user or operator or for use later in report generation or later use in responding to a request for archived sensor data.

FIG. 11 is a flow diagram illustrating a process for processing queries for archived sensor data. A user or operator may submit a request to the controller 20 for archived sensor data via the user interface of controller 20. Controller 20 receives the request for the sensor data (step 1110) and sensor module 210 of controller 20 retrieves the data from data store 25 for the sensors specified in the request (step 1120). Controller 20 then transmits the requested archived sensor data to the user or operator (step 1130). In an embodiment, controller 20 may generate an email, a text message, a video message, and/or an image that includes the requested archived sensor data, just to name a few. In an embodiment, controller 20 generates a web page that displays a report that provides the archived sensor data for the requested sensors specified in the request including displaying any sensor data, such as images and video that has been archived from the sensor devices.

FIG. 12 is a flow diagram illustrating a process for processing a delete data command according to an embodiment. A user or operator may submit a request to the controller 20 to delete archived sensor data for one or more sensor devices via the user interface of controller 20. Controller 20 receives the request to delete archived sensor data (step 1210) and executes a query on the data store 25 to delete the data specified in the request (step 1220). Controller 20 then transmits an acknowledgement to the operator or user if the request was successfully carried out or a failure message if the request to delete the data could not be completed (step 1230).

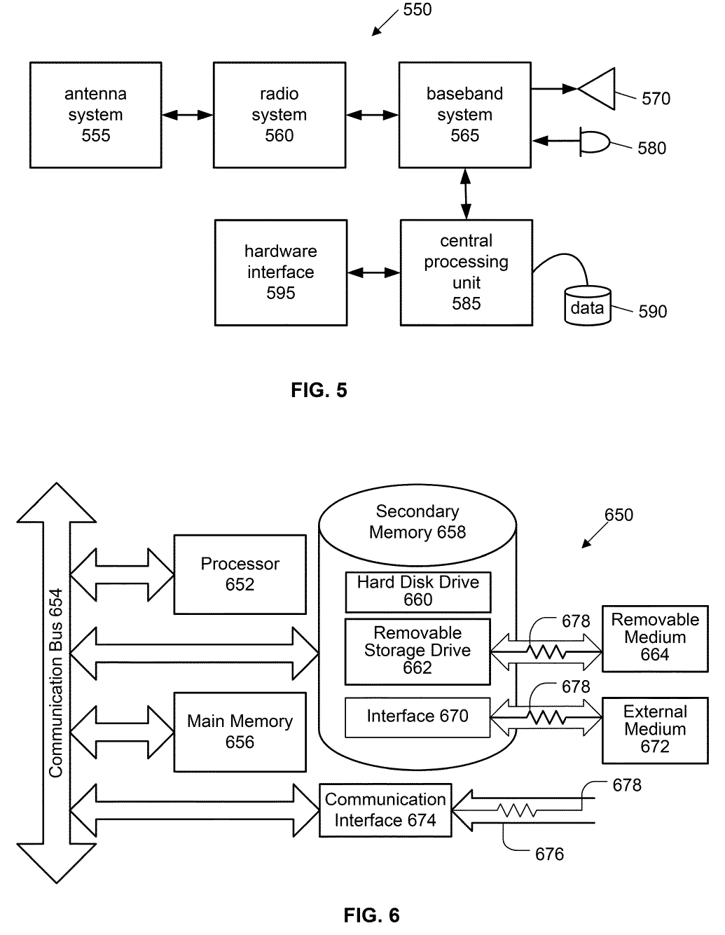

FIG. 5 is a block diagram illustrating an embodiment of an exemplary wireless communication device 550 that may be used in connection with various embodiments described herein. For example, the wireless communication device 550 may be used in conjunction with a sensor or user device as previously described with respect to FIG. 1. However, other wireless communication devices and/or architectures may also be used, as will be clear to those skilled in the art. The wireless networks can send data directly to the computer, or the sensors can use group data collection to a baseband system before entering data into the computer.

In the illustrated embodiment, wireless communication device 550 comprises an antenna system 555, a radio system 560, a baseband system 565, a speaker 570, a microphone 580, a central processing unit (“CPU”) 585, a data storage area 590, and a hardware interface 595. In the wireless communication device 550, radio frequency (“RF”) signals are transmitted and received over the air by the antenna system 555 under the management of the radio system 560.

In one embodiment, the antenna system 555 may comprise one or more antennae and one or more multiplexors (not shown) that perform a switching function to provide the antenna system 555 with transmit and receive signal paths. In the receive path, received RF signals can be coupled from a multiplexor to a low noise amplifier (not shown) that amplifies the received RF signal and sends the amplified signal to the radio system 560.

In alternative embodiments, the radio system 560 may comprise one or more radios that are configured to communication over various frequencies. In one embodiment, the radio system 560 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 560 to the baseband system 565.

If the received signal contains audio information, then baseband system 565 decodes the signal and converts it to an analog signal. Then the signal is amplified and sent to the speaker 570. The baseband system 565 also receives analog audio signals from the microphone 580. These analog audio signals are converted to digital signals and encoded by the baseband system 565. The baseband system 565 also codes the digital signals for transmission and generates a baseband transmit audio signal that is routed to the modulator portion of the radio system 560. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 555 where the signal is switched to the antenna port for transmission.

The baseband system 565 is also communicatively coupled with the central processing unit 585. The central processing unit 585 has access to a data storage area 590. The central processing unit 585 is preferably configured to execute instructions (i.e., computer programs or software) that can be stored in the data storage area 590. Computer programs can also be received from the baseband processor 565 and stored in the data storage area 590 or executed upon receipt. Such computer programs, when executed, enable the wireless communication device 550 to perform the various functions of the present invention as previously described. For example, data storage area 590 may include various software modules (not shown) such as those modules previously described with respect to FIG. 2.

In this description, the term “computer readable medium” is used to refer to any media used to provide executable instructions (e.g., software and computer programs) to the wireless communication device 550 for execution by the central processing unit 585. Examples of these media include the data storage area 590, microphone 580 (via the baseband system 565), antenna system 555 (also via the baseband system 565), and hardware interface 495. These computer readable mediums are means for providing executable code, programming instructions, and software to the wireless communication device 550. The executable code, programming instructions, and software, when executed by the central processing unit 585, preferably cause the central processing unit 585 to perform the inventive features and functions previously described herein.

The central processing unit 585 is also preferably configured to receive notifications from the hardware interface 595 when new devices are detected by the hardware interface. Hardware interface 595 can be a combination electromechanical detector with controlling software that communicates with the CPU 485 and interacts with new devices. The hardware interface 595 may be a firewire port, a USB port, a Bluetooth or infrared wireless unit, or any of a variety of wired or wireless access mechanisms. Examples of hardware that may be linked with the device 550 include data storage devices, computing devices, headphones, microphones, and the like.

FIG. 6 is a block diagram illustrates an embodiment of an exemplary computer system 650 that may be used in connection with various embodiments described herein. For example, the computer system 650 may be used in conjunction with a controller server, sensor, or user device such as those previously described with respect to FIG. 1. However, other computer systems and/or architectures may be used, as will be clear to those skilled in the art.

The computer system 650 preferably includes one or more processors, such as processor 652. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 652.

The processor 652 is preferably connected to a communication bus 654. The communication bus 654 may include a data channel for facilitating information transfer between storage and other peripheral components of the computer system 650. The communication bus 654 further may provide a set of signals used for communication with the processor 652, including a data bus, address bus, and control bus (not shown). The communication bus 654 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 650 preferably includes a main memory 556 and may also include a secondary memory 658. The main memory 6556 provides storage of instructions and data for programs executing on the processor 652. The main memory 656 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 658 may optionally include a hard disk drive 660 and/or a removable storage drive 662, for example a floppy disk drive, a magnetic tape drive, a compact disc (“CD”) drive, a digital versatile disc (“DVD”) drive, etc. The removable storage drive 662 reads from and/or writes to a removable storage medium 664 in a well-known manner. Removable storage medium 664 may be, for example, a floppy disk, magnetic tape, CD, DVD, etc.

The removable storage medium 664 is preferably a computer readable medium having stored thereon computer executable code (i.e., software) and/or data. The computer software or data stored on the removable storage medium 664 is read into the computer system 650 as electrical communication signals 678.

In alternative embodiments, secondary memory 658 may include other similar means for allowing computer programs or other data or instructions to be loaded into the computer system 650. Such means may include, for example, an external storage medium 672 and an interface 670. Examples of external storage medium 672 may include an external hard disk drive or an external optical drive, or and external magneto-optical drive.

Other examples of secondary memory 658 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 6572 and interfaces 670, which allow software and data to be transferred from the removable storage unit 672 to the computer system 650.

Computer system 650 may also include a communication interface 674. The communication interface 674 allows software and data to be transferred between computer system 650 and external devices (e.g. printers), networks, or information sources. For example, computer software or executable code may be transferred to computer system 650 from a network server via communication interface 674. Examples of communication interface 674 include a modem, a network interface card (“NIC”), a communications port, a PCMCIA slot and card, an infrared interface, and an IEEE 1394 fire-wire, just to name a few.

Communication interface 674 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 674 are generally in the form of electrical communication signals 678. These signals 678 are preferably provided to communication interface 674 via a communication channel 676. Communication channel 676 carries signals 678 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 656 and/or the secondary memory 658. Computer programs can also be received via communication interface 674 and stored in the main memory 656 and/or the secondary memory 658. Such computer programs, when executed, enable the computer system 650 to perform the various functions of the present invention as previously described.

In this description, the term “computer readable medium” is used to refer to any media used to provide computer executable code (e.g., software and computer programs) to the computer system 650. Examples of these media include main memory 656, secondary memory 658 (including hard disk drive 660, removable storage medium 664, and external storage medium 672), and any peripheral device communicatively coupled with communication interface 674 (including a network information server or other network device). These computer readable mediums are means for providing executable code, programming instructions, and software to the computer system 650.

In an embodiment that is implemented using software, the software may be stored on a computer readable medium and loaded into computer system 650 by way of removable storage drive 662, interface 670, or communication interface 674. In such an embodiment, the software is loaded into the computer system 650 in the form of electrical communication signals 678. The software, when executed by the processor 652, preferably causes the processor 652 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A sensor monitoring system comprising:
a computer readable storage device for storing computer executable programmed modules;
a processor communicatively coupled with the computer readable storage device for executing programmed modules stored therein;
a control module stored in the computer readable storage device, the control module configured to manage and control the wireless sensor monitoring system;
a sensor module stored in the computer readable storage device, the sensor module configured to automatically detect a plurality of sensor devices deployed at a remote location and manage data access to and from the plurality of sensor devices; and
a display and mapping module stored in the computer readable storage device, the display and mapping module configured to display a map interface including an image of the remote location being monitored by the plurality of sensors and a location of each of the plurality of sensors deployed at the remote location.

2. The sensor monitoring system of claim 1 wherein the sensor module is further configured to communicate with one more sensor devices via a gateway device, the gateway device configured to translate communications from the sensor module to a proprietary format used by the one or more sensor devices, and to translate communications received from the one or more sensor devices from the proprietary format used by the sensor device into a format used by the sensor module.

3. The sensor monitoring system of claim 1 wherein the map interface includes a sensor detail interface for requesting sensor data from a sensor deployed at the remote location and for displaying the sensor data received from the sensor.

4. The sensor monitoring system of claim 1 wherein the control server includes a rules module, and wherein the rules module is configured to:
receive a set of user-defined rules for processing sensor data, the user-defined rules including a trigger event and a set of actions to be performed if the trigger event occurs; and
execute the set of actions for a user defined rule if the trigger event for the user-defined rule occurs.

5. The sensor monitoring system of claim 4 wherein the user-defined rules include a trigger event rule, the trigger event rule including a set of actions to be performed by the controller server if the one or more events are triggered by the sensor devices.

6. The sensor monitoring system of claim 4 wherein the user-defined rules include a timer event rule, the trigger event for the timer event rule being a specified time at which the set of actions are to be performed.

7. The sensor monitoring system of claim 4 wherein in response to executing the set of actions for a user defined rule, the rules module is further configured to instruct the sensor module to:
request sensor data from one or more sensor devices of the plurality of sensor devices;
receive the sensor data from one or more sensor devices; and
generate an electronic notification to a user that includes a representation of at least a portion of the sensor data received from the sensor devices.

8. A computer implemented method for operating a sensor monitoring system, where one or more processors are programmed to perform steps comprising:
detecting a plurality of portable sensor devices deployed at a remote location, the plurality of portable sensor devices being detected using a controller server;
receiving, at the controller server, sensor data from the plurality of sensor devices that have been detected; and
displaying a map interface displaying an image of the remote location being monitored by the plurality of sensors and a location of each of the plurality of sensors deployed at the remote location.

9. The method of claim 8 wherein receiving sensor data from the plurality of sensor devices that have been detected further comprises:
receiving sensor data from one or more sensor devices via a gateway device, the gateway device being configured to translate communications from the sensor module to a proprietary format used by the one or more sensor devices.

10. The method of claim 8, further comprising:
displaying sensor detail interface for requesting sensor data from a sensor deployed at the remote location and for displaying the sensor data received from the sensor.

11. The method of claim 8, further comprising:
receiving a set of user-defined rules for processing sensor data, the rules including a trigger event and a set of actions to be performed if the trigger event occurs; and
executing the set of actions for a user defined rule if the trigger event for the user-defined rule occurs.

12. The method of claim 11 wherein the user defined rules include a trigger event rule, the trigger event rule including a set of actions to be performed by the controller server if the one or more events are triggered by the sensor devices.

13. The method of claim 11 wherein the user defined rules include a timer event rule, the trigger event for the timer event rule being a specified time at which the set of actions are to be performed.

14. The method of claim 11 wherein executing the set of actions for the user defined rules further comprises:
requesting sensor data from one or more sensor devices of the plurality of sensor devices;
receiving the sensor data from one or more sensor devices; and
generating an electronic notification to a user that includes a representation of at least a portion of the sensor data received from the sensor devices.

15. A computer-readable storage medium having stored thereon one or more sequences of instructions for causing one or more processors to perform the steps for operating a sensor monitoring system, the steps comprising:
detecting a plurality of portable sensor devices deployed at a remote location;
receiving sensor data from the plurality of sensor devices that have been detected; and
displaying a map interface displaying an image of the remote location being monitored by the plurality of sensors and a location of each of the plurality of sensors deployed at the remote location.

16. The computer-readable medium of claim 15 wherein the steps further comprise:
receiving sensor data from one or more sensor devices via a gateway device, the gateway device being configured to translate communications from the sensor module to a proprietary format used by the one or more sensor devices.

17. The computer-readable medium of claim 16 wherein the steps further comprise:
displaying sensor detail interface for requesting sensor data from a sensor deployed at the remote location and for displaying the sensor data received from the sensor.

18. The computer-readable medium of claim 15 wherein the steps further comprise:
receiving a set of user-defined rules for processing sensor data, the rules including a trigger event and a set of actions to be performed if the trigger event occurs; and
executing the set of actions for a user defined rule if the trigger event for the user-defined rule occurs.

19. The computer-readable medium of claim 18, wherein the rules include a trigger event rule, the trigger event rule including a set of actions to be performed by the controller server if the one or more events are triggered by the sensor devices.

20. The computer-readable medium of claim 18, wherein the rules include a timer event rule, the trigger event for the timer event rule being a specified time at which the set of actions are to be performed.

21. The computer-readable medium of claim 15 wherein the step of executing the set of actions for the user-defined rule further comprises the steps of:
requesting sensor data from one or more sensor devices of the plurality of sensor devices;
receiving the sensor data from one or more sensor devices; and
generate an electronic notification to a user that includes a representation of at least a portion of the sensor data received from the sensor devices.
